(19) United States
(12) Patent Application Publication
(10) Pub. No.: US 2014/0192899 A1
(43) Pub. Date: Jul. 10, 2014

(54) METHOD AND APPARATUS FOR REFERRING TO BITSTREAM ADDRESS RELATED INFORMATION DERIVED FROM SEGMENT OF MULTI-TILE PICTURE TO DETERMINE BITSTREAM START ADDRESS OF TILE OF MULTI-TILE PICTURE

(71) Applicant: MEDIATEK INC., Hsin-Chu (TW)

(72) Inventors: Chih-Ming Wang, Hsinchu County (TW); Chia-Yun Cheng, Hsinchu County (TW); Yung-Chang Chang, New Taipei City (TW)

(73) Assignee: MEDIATEK INC., Hsin-Chu (TW)

(21) Appl. No.: 14/142,929

(22) Filed: Dec. 30, 2013

Related U.S. Application Data
(60) Provisional application No. 61/750,413, filed on Jan. 9, 2013.

(51) Int. Cl. H04N 19/593; H04N 19/174

(52) U.S. Cl. CPC H04N 19/00763; H04N 19/00272
USPC 375/240.26

(57) ABSTRACT

A tile processing method includes at least the following steps: parsing a bitstream of at least a multi-tile picture for deriving bitstream address related information from a segment header of at least a specific segment of the multi-tile picture; and utilizing a tile processing circuit for receiving at least the bitstream address related information and referring to at least the received bitstream address related information to determine a bitstream start address of a specific tile of the multi-tile picture.

### CROSS REFERENCE TO RELATED APPLICATIONS

This application claims the benefit of U.S. provisional application No. 61/750,413, filed on Jan. 9, 2013 and incorporated herein by reference.

### BACKGROUND

The disclosed embodiments of the present invention relate to processing a multi-tile picture, and more particularly, to a method and apparatus for referring to bitstream address related information derived from a segment (e.g., a slice) of a multi-tile picture to determine a bitstream start address of a tile of the multi-tile picture.

As proposed in High-Efficiency Video Coding (HEVC) specification, one picture may be partitioned into multiple tiles, and one tile may be partitioned into a plurality of slices. Inside each slice, largest coding units (LCUs) are raster scanned. Inside each tile, slices are scanned sequentially. Inside each multi-tile picture, tiles are raster scanned. Alternatively, as proposed in HEVC specification, one picture may be partitioned into multiple slices, and one slice may be partitioned into a plurality of tiles. Inside each tile, largest coding units (LCUs) are raster scanned. Insides each slice, tiles are raster scanned. Inside each multi-tile picture, slices are scanned sequentially. In one conventional decoding design, a bitstream of the multi-tile picture would be decoded sequentially to therefor obtain tiles in the scan order.

In accordance with the HEVC specification, there is no start code defined in the bitstream for each tile. Hence, due to absence of a bitstream start address of each tile in the bitstream, direct decoding of one tile within the multi-tile picture without decoding of previous tile(s) within the same multi-tile picture cannot be achieved by the conventional decoding design. Besides, due to absence of the bitstream start address of each tile in the bitstream, parallel decoding of multiple tiles within the same multi-tile picture cannot be achieved by the conventional decoding design.

### SUMMARY

In accordance with exemplary embodiments of the present invention, a method and apparatus for referring to bitstream address related information derived from a segment (e.g., a slice) of a multi-tile picture to determine a bitstream start address of a tile of the multi-tile picture are proposed, to solve the aforementioned problems.

According to a first aspect of the present invention, an exemplary tile processing method is disclosed. The exemplary tile processing method includes at least the following steps: parsing a bitstream of a multi-tile picture for deriving bitstream address related information from a segment header of at least a specific segment of the multi-tile picture; and utilizing a tile processing circuit for receiving at least the bitstream address related information and referring to at least the received bitstream address related information to determine a bitstream start address of a specific tile of the multi-tile picture.

According to a second aspect of the present invention, an exemplary tile processing apparatus is disclosed. The tile processing apparatus includes a demultiplexer and tile processing circuit. The demultiplexer is arranged to parse a bitstream of a multi-tile picture for deriving bitstream address related information from a segment header of at least a specific segment of the multi-tile picture. The tile processing circuit is arranged for receiving at least the bitstream address related information, and referring to at least the received bitstream address related information to determine a bitstream start address of a specific tile of the multi-tile picture.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a video processing system employing a proposed tile processing apparatus according to an embodiment of the present invention.

FIG. 2 is a diagram illustrating an example of tiles included in a multi-tile picture.

FIG. 3 is a diagram illustrating an example of slices included in the multi-tile picture.

FIG. 4 is a diagram illustrating LCUs included in the multi-tile picture.

FIG. 5 is a diagram illustrating an example of a bitstream structure of the multi-tile picture.

FIG. 6 is a flowchart illustrating a first tile processing method according to an embodiment of the present invention.

FIG. 7 is a diagram illustrating an example of slices included in a multi-tile picture.

FIG. 8 is a diagram illustrating an example of tiles included in the multi-tile picture.

FIG. 9 is a diagram illustrating LCUs included in the multi-tile picture.

FIG. 10 is a diagram illustrating another example of a bitstream structure of the multi-tile picture.

FIG. 11 is a flowchart illustrating a second tile processing method according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

The main concept of the present invention is to use at least header information available in a bitstream of a multi-tile picture to obtain a bitstream start address of any tile of the multi-tile picture. More specifically, a segment header of a specific segment (e.g., a slice header of a specific slice) of the multi-tile picture is parsed from the bitstream of the multi-tile picture, and then at least address related information derived from the segment header is referenced to generate a bitstream start address of a specific tile requested by an application. Further details of the proposed tile processing scheme are described as below.

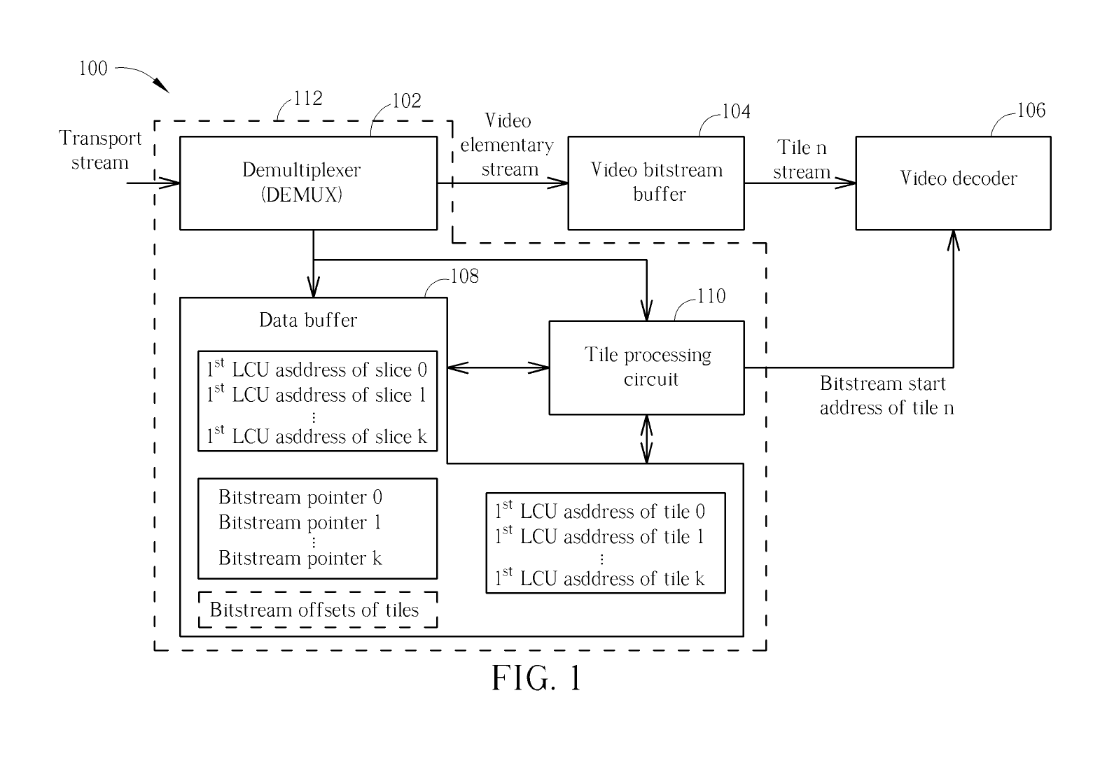

Please refer to FIG. 1, which is a block diagram illustrating a video processing system employing a proposed tile processing apparatus according to an embodiment of the present invention. The video processing system 100 includes a demultiplexer (DEMUX) 102, a video bitstream buffer (e.g., a memory) 104, a video decoder 106, a data buffer (e.g., a memory) 108, and a tile processing circuit 110, wherein the DEMUX 102, the tile processing circuit 110 and the data buffer 108 serve as the proposed tile processing apparatus 112 for identifying a bitstream start address of any tile within a multi-tile picture. The transport stream may include an audio elementary stream, a video elementary stream, etc. Hence, the DEMUX 102 demultiplexes the transport stream, and outputs a video elementary stream of at least one multi-tile picture to the video bitstream buffer 104. When the bitstream start address of a specific tile (e.g., tile n) is determined by the tile processing apparatus 112, the video decoder 106 can only read a stream of the specific tile (e.g., a tile n stream) from the video elementary stream buffered in the video bitstream buffer 104, and directly decodes the stream of the specific tile (e.g., the tile n stream) to recover an image content of the specific tile. Hence, as the tile processing apparatus 112 is capable of determining a bitstream start address of any tile within a multi-tile picture, a stream of one or more tiles can be directly retrieved from the video elementary stream in the video bitstream buffer 104. In this way, the video processing system 100 is able to support a variety of applications, such as multi-core processing of multiple tiles, and ROI (region of interest) decoding of a single tile. Technical features of the proposed tile processing apparatus 112 are detailed as below.

Regarding the tile processing apparatus 112, the DEMUX 102 is further arranged to parse a bitstream of a multi-tile picture for deriving bitstream address related information from a segment header of at least a specific segment of the multi-tile picture, and stores the bitstream address related information into the data buffer 108; and the tile processing circuit 110 is arranged for receiving at least the bitstream address related information, and referring to at least the received bitstream address related information to determine a bitstream start address of a specific tile of the multi-tile picture. Hence, when demultiplexing the transport stream, the DEMUX 102 also parses the video elementary stream to obtain bitstream address related information from each segment header. Suppose that the transport stream to be processed by the video processing system 100 complies with the High-Efficiency Video Coding (HEVC) specification, each segment is a slice. However, this is not meant to be a limitation of the present invention. Any multi-tile picture processing system using at least header information of a segment (which may include tiles or may be included in one tile) available in a bitstream to identify a bitstream start address of a desired tile falls within the scope of the present invention. For clarity and simplicity, the following assumes that the segment is a slice as defined in HEVC.

In a first scenario, one picture is partitioned into multiple tiles, and each tile is partitioned into one or more slices. Since the aforementioned specific segment (e.g., a specific slice) is included in the aforementioned specific tile, the aforementioned specific segment is not larger than the aforementioned specific tile. More specifically, the specific slice is at least a portion (i.e., part or all) of the specific tile. The bitstream address related information obtained from the parsing operation of the slice header of the specific slice may include the first largest coding unit (LCU) address of the specific slice and the associated bitstream pointer indicative of the bitstream start address of the specific slice.

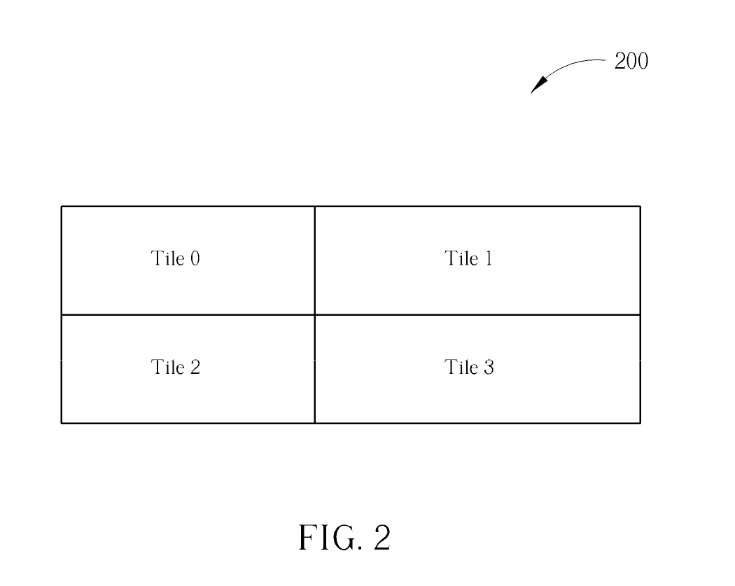

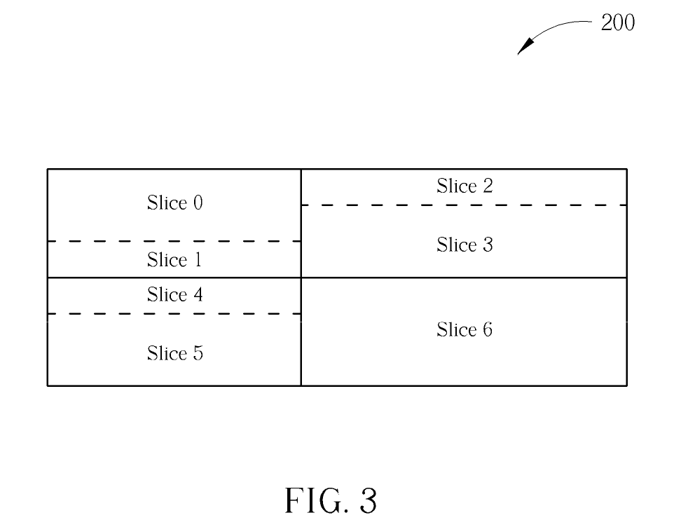

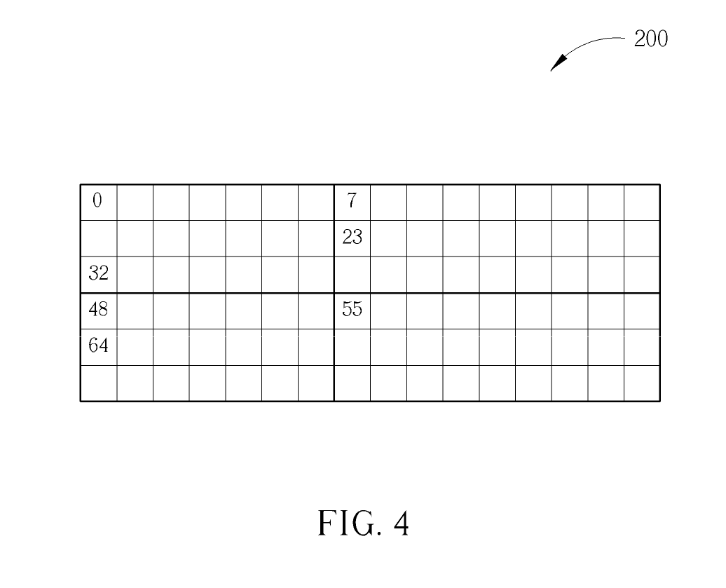

Please refer to FIGS. 2-4. FIG. 2 is a diagram illustrating an example of tiles included in a multi-tile picture. FIG. 3 is a diagram illustrating an example of slices included in the multi-tile picture. FIG. 4 is a diagram illustrating LCUs included in the multi-tile picture. As shown in FIG. 2, the exemplary multi-tile picture 200 has two vertical partitions and two horizontal partitions, thus resulting in four tiles Tile 0, Tile 1, Tile 2 and Tile 3. This is for illustrative purposes only, and is not meant to be a limitation of the present invention. In practice, the number of tiles and the sizes of tiles may be adjusted, depending upon actual design consideration. In accordance with the HEVC specification, the top-left tile Tile 0 is scanned first, the top-right tile Tile 1 is scanned after the top-left tile Tile 0, the bottom-left tile Tile 2 is scanned after the top-right tile Tile 1, and the bottom-right tile Tile 3 is scanned after the bottom-left tile Tile 2. As shown in FIG. 3, each of tiles Tile 0-Tile 2 is partitioned into two slices, and the whole tile Tile 3 is treated as the slice Slice 6. This is for illustrative purposes only, and is not meant to be a limitation of the present invention. In practice, the number of slices included in one tile may be adjusted, depending upon actual design consideration. In accordance with the HEVC specification, LCUs in each tile is raster scanned. Hence, with regard to the top-left tile Tile 0, the top slice Slice 0 is scanned first, and the bottom slice Slice 1 is scanned after the top slice Slice 0; with regard to the top-right tile Tile 1, the top slice Slice 2 is scanned first, and the bottom slice Slice 3 is scanned after the top slice Slice 2; and with regard to the bottom-left tile Tile 2, the top slice Slice 4 is scanned first, and the bottom slice Slice 5 is scanned after the top slice Slice 4. In addition, as shown in FIG. 4, successive LCUs of the multi-tile picture 200 are arranged in a raster scan order, such that the first LCU of the top slice Slice 0 of the top-left tile Tile 0 is indexed by ‘0’, the first LCU of the bottom slice Slice 1 of the top-left tile Tile 0 is indexed by ‘32’, the first LCU of the top slice Slice 2 of the top-right tile Tile 1 is indexed by ‘7’, the first LCU of the bottom slice Slice 3 of the top-right tile Tile 1 is indexed by ‘23’, the first LCU of the top slice Slice 4 of the bottom-left tile Tile 2 is indexed by ‘48’, the first LCU of the bottom slice Slice 5 of the bottom-left tile Tile 2 is indexed by ‘64’, and the first LCU of the slice Slice 6 of the bottom-right tile Tile 3 is indexed by ‘55’. In other words, the first LCU addresses of the slices Slice 0-Slice 6 are ‘0’, ‘32’, ‘7’, ‘23’, ‘48″64’ and ‘55’, respectively.

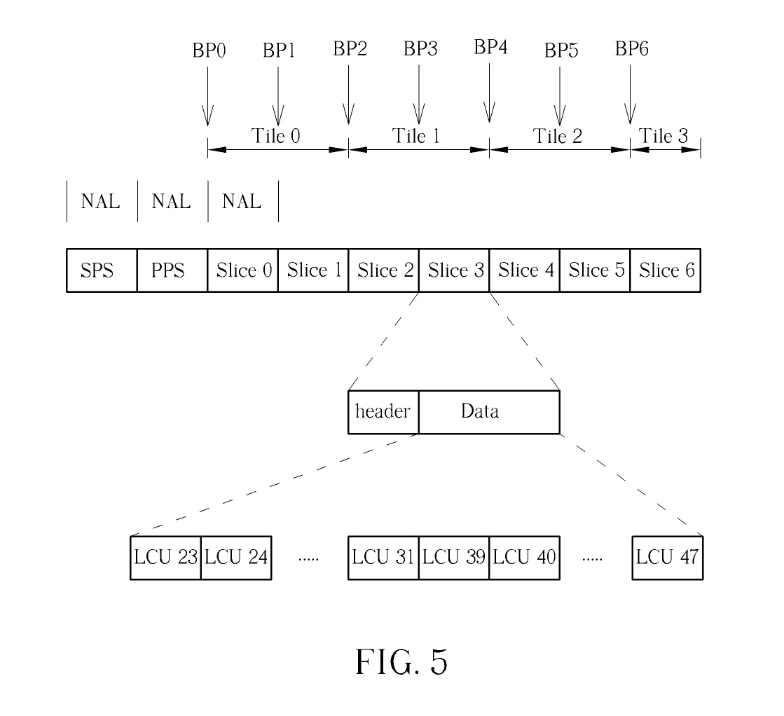

Please refer to FIG. 5, which is a diagram illustrating an example of a bitstream structure of the multi-tile picture. As mentioned above, slices in each tile are scanned sequentially; and tiles in the multi-tile picture are raster scanned. Hence, stream data of slices Slice 0-Slice 6 would be sequentially arranged in the video elementary stream demultiplexed and parsed by the DEMUX 102 shown in FIG. 1, where the stream of each slice includes a slice header (which includes auxiliary information) and a slice data (which is composed of encoded LCU data). Taking the bitstream of the slice Slice 3 for example, the slice data is composed of encoded data of LCUs indexed by ‘23’-'31′ and ‘39’-'47′. It should be noted that, in accordance with the HEVC specification, the slice header would have the syntax slice segment address to indicate the first LCU address of the slice. Hence, when the DEMUX 102 parses the HEVC bitstream of the multi-tile picture 200, the DEMUX 102 obtains the first LCU address of each of slices Slice 0-Slice 6 by finding the syntax slice segment address included in the corresponding slice header, and stores the first LCU address of each of slices Slice 0-Slice 6 into the data buffer 108.

Besides, when the DEMUX 102 parses the HEVC bitstream of the multi-tile picture 200, the DEMUX 102 also obtains a bitstream start address of each of slices Slice 0-Slice 6 in response to parsing the slice header of the corresponding slice. More specifically, when the DEMUX 102 finds that it is currently parsing a slice header of a specific slice, a bitstream start address of the specific slice can be determined correspondingly. In this embodiment, the bitstream pointers BP0-BP6 determined by the DEMUX 102 would point to respective bitstream start addresses of streams of slices Slice 0-Slice 6 stored in the video bitstream 104.

Based on the bitstream pointers and the first LCU addresses of slices Slice 0-Slice 6, a bitstream start address of any tile of the multi-tile picture 200 can be easily identified. As shown in FIG. 5, there is higher-level information, such as a sequence parameter set (SPS) and a picture parameter set (PPS), included in the bitstream of the multi-tile picture, where the PPS would have the tile syntax indicative of tile partitioning information (i.e., arrangement of tiles in a multi-tile picture). Hence, based on the tile partitioning information parsed by the DEMUX 102, the tile processing circuit 110 is able to calculate the first LCU address of each tile included in the multi-tile picture. The exemplary tile syntax in HEVC picture parameter set is illustrated as below.

if( tiles_enabled_flag ) {
num_tile_columns_minus1
num_tile_rows_minus1
uniform_spacing_flag
if( !uniform_spacing_flag ) {
for( i = 0; i < num_tile_columns_minus1; i++ )
column_width_minus1[ i ]
for( i = 0; i < num_tile_rows_minus1; i++ )
row_height_minus1[ i ]
}

The syntax elements num_tile_columns_minus1 and num_tile_rows_minus1 indicate the number of vertical partitions of the multi-tile picture and the number of horizontal partitions of the multi-tile picture. Hence, the tile processing circuit 110 knows the number of tile included in the multi-tile picture according to the syntax elements num_tile_columns_minus1 and num_tile_rows_minus1. The syntax element uniform_spacing_flag decides if widths of the tiles are the same and heights of the tiles are also the same. If the syntax element uniform_spacing_flag indicates that widths of the tiles are not the same and heights of the tiles are not the same, the syntax element column_width_minus1 is used to indicate the width of each tile, and the syntax element row_height_minus1 is used to indicate the height of each tile. In this example, the tile processing circuit 110 refers to the tile partitioning information to determine that the first LCU addresses of tiles Tile 0-Tile 3 are indexed by ‘0’, ‘7’, ‘48’ and ‘55’, respectively. Besides, the tile processing circuit 110 may store the first LCU addresses of tiles Tile 0-Tile 3 into the data buffer 108.

As shown in FIG. 3, each of tiles Tile 0-Tile 2 has more than one slice. Since the first LCU of the top-left tile Tile 0 is also the first LCU of the top slice Slice 0 of the top-left tile Tile 0, the top slice Slice 0 (i.e., the first slice included in the top-left tile Tile 0 according to the scan order) is regarded as a key slice of the top-left tile Tile 0. Similarly, the top slice Slice 2 (i.e., the first slice included in the top-right tile Tile 1 according to the scan order) is regarded as a key slice of the top-right tile Tile 1, the top slice Slice 4 (i.e., the first slice included in the bottom-left tile Tile 2 according to the scan order) is regarded as a key slice of the bottom-left tile Tile 2, and the slice Slice 6 (i.e., the first slice included in the bottom-right tile Tile 3 according to the scan order) is regarded as a key slice of the bottom-right tile Tile 3. In this embodiment, the tile processing circuit 110 finds one of the key slices that has the first LCU address identical to the first LCU address of the specific tile requested by the application, and then sets the bitstream start address of the specific tile by the bitstream start address pointed to by the bitstream point of the found key slice.

In a case where an ROI decoding application wants to decode the specific tile only, the tile processing circuit 110 finds a specific slice (i.e., a key slice) with the first LCU address identical to the first LCU address of the specific tile, and outputs the bitstream start address of the specific slice as the bitstream start address of the specific tile. Therefore, the video decoder 106 directly retrieves the bitstream of the specific tile from the video elementary stream stored in the video bitstream buffer 104, and accomplishes the ROI decoding for the specific tile. In another case where a multi-core processing application wants to decode multiple specific tiles simultaneously, the tile processing circuit 110 finds specific slices (i.e., key slices) with the first LCU addresses identical to the first LCU addresses of the specific tiles, respectively, and outputs the bitstream start addresses of the specific slices as the bitstream start addresses of the specific tiles. Therefore, the video decoder 106 directly retrieves bitstreams of the specific tiles from the video elementary stream stored in the video bitstream buffer 104, and accomplishes the multi-core processing for the specific tiles.

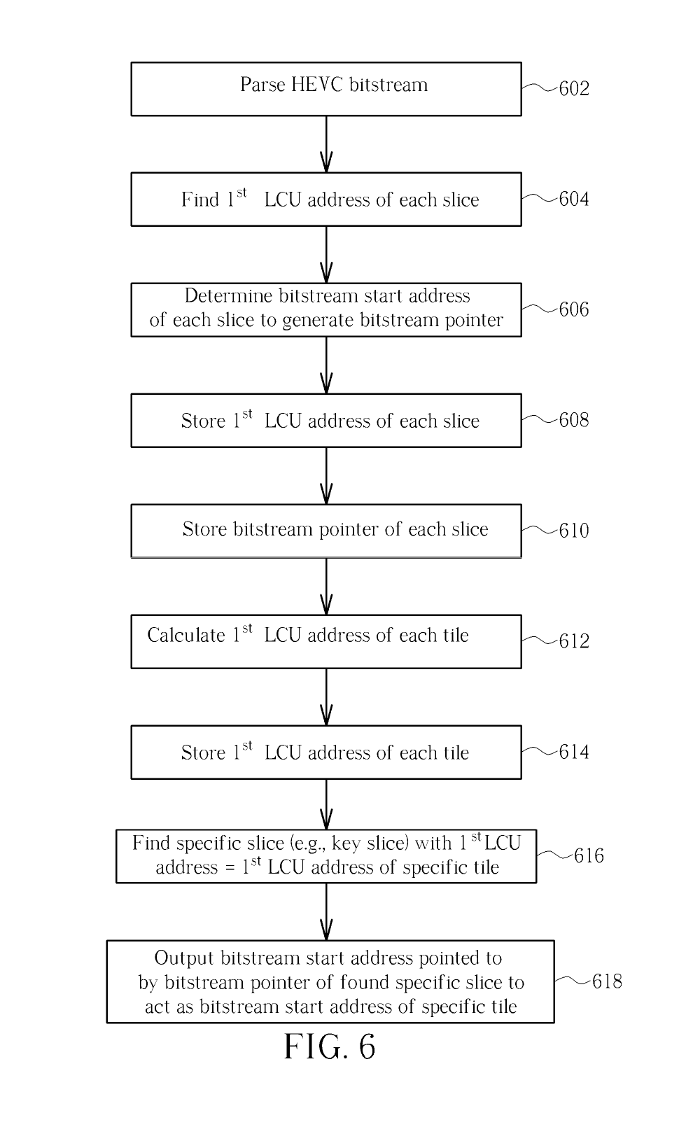

Please refer to FIG. 6, which is a flowchart illustrating a first tile processing method according to an embodiment of the present invention. The first tile processing method may be employed by the tile processing apparatus 100 under the first scenario. Provided that the result is substantially the same, the steps are not required to be executed in the exact order shown in FIG. 6. Besides, the flow is allowed to omit one or more of steps and/or include one or more additional steps, depending upon actual design consideration. The operation of getting the bitstream start address for a specific tile may be briefly summarized as follows.

Step 602: Parse an HEVC bitstream (e.g., a video elementary stream having the multi-tile picture to be processed).

Step 604: Find the first LCU address of each slice according to the syntax slice_segment_address in the slice header of each slice.

Step 606: Determine a bitstream start address of each slice to generate a bitstream pointer.

Step 608: Store the first LCU address of each slice into a data buffer (e.g., a memory).

Step 610: Store the bitstream pointer of each slice into the data buffer.

Step 612: Calculate the first LCU address of each tile according to the tile syntax in the picture parameter set (PPS).

Step 614: Store the first LCU address of each tile into the data buffer.

Step 616: Find a specific slice (e.g., a key slice) with the first LCU address identical to the first LCU address of a specific tile requested by an application.

Step 618: Output the bitstream start address pointed to by the bitstream pointer of the found specific slice to act as the bitstream start address of the specific tile.

It should be noted that steps 616 and 618 may be repeated to thereby output bitstream start addresses of multiple specific tiles requested by the application. As a person skilled in the pertinent art can readily understand details of each step shown in FIG. 6 after reading above paragraphs directed to the tile processing apparatus 100 operating under the first scenario, further description is omitted here for brevity.

In a second scenario, one picture is partitioned into multiple slices, and each slice is partitioned into one or more tiles. Since the aforementioned specific tile is included in the aforementioned specific segment (e.g., a specific slice), the aforementioned specific tile is not larger than the aforementioned specific segment. More specifically, the specific tile maybe at least a portion (i.e., part or all) of the specific slice. When a slice includes more than one tile, the bitstream address related information obtained from the parsing operation of the slice header of the specific slice may include the first largest coding unit (LCU) address of the specific slice, the associated bitstream pointer indicative of the bitstream start address of the specific slice, and a bitstream offset of at least one tile included in the specific slice.

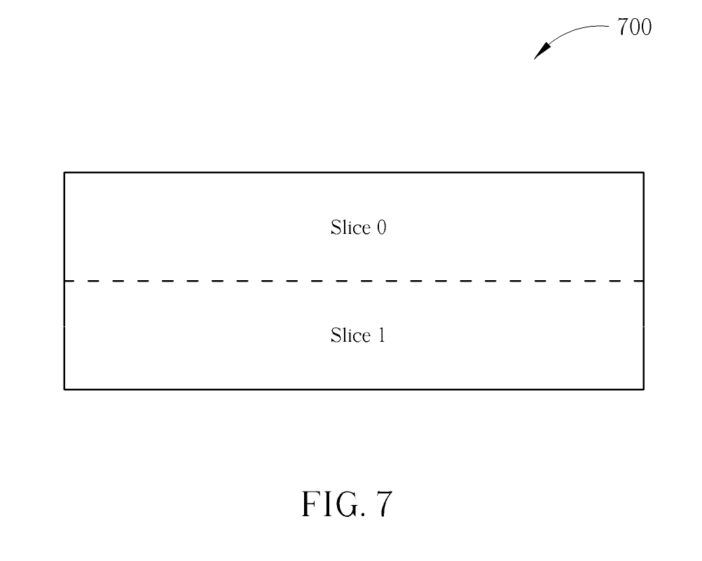

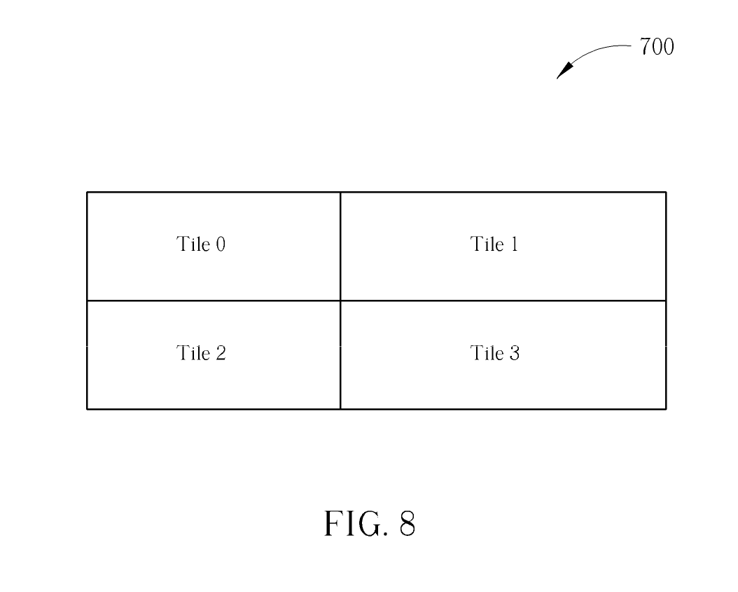

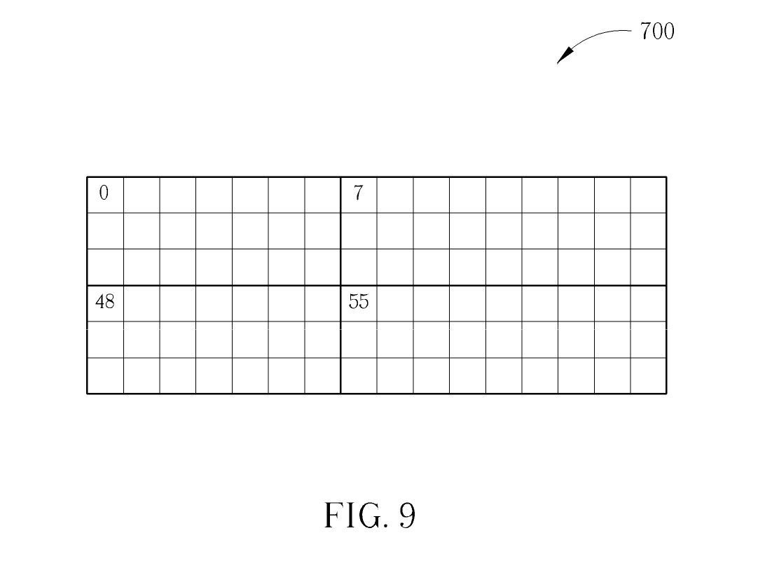

Please refer to FIGS. 7-9. FIG. 7 is a diagram illustrating an example of slices included in a multi-tile picture. FIG. 8 is a diagram illustrating an example of tiles included in the multi-tile picture. FIG. 9 is a diagram illustrating LCUs included in the multi-tile picture. As shown in FIG. 7, the multi-tile picture 700 has two horizontal partitions, thus resulting in two slices Slice 0 and Slice 1. As shown in FIG. 8, each of slices Slice 0 and Slice 1 is partitioned into two tiles. This is for illustrative purposes only, and is not meant to be a limitation of the present invention. In practice, the number of slices/tiles and the sizes of slices/tiles may be adjusted, depending upon actual design consideration. In accordance with the HEVC specification, the left tile Tile 0 of the top slice Slice 0 is scanned first, the right tile Tile 1 of the top slice Slice 0 is scanned after the left tile Tile 0 of the top slice Slice 0, the left tile Tile 2 of the bottom slice Slice 1 is scanned after the right tile Tile 1 of the top slice Slice 0, and the right tile Tile 3 of the bottom slice Slice 1 is scanned after the left tile Tile 2 of the bottom slice Slice 1. As shown in FIG. 9, successive LCUs of the multi-tile picture 700 are arranged in a raster scan order, such that the first LCU of the left tile Tile 0 of the top slice Slice 0 is indexed by ‘0’, the first LCU of the right tile Tile 1 of the top slice Slice 0 is indexed by ‘7’, the first LCU of the left tile Tile 2 of the bottom slice Slice 1 is indexed by ‘48’, and the first LCU of the right tile Tile 3 of the bottom slice Slice 1 is indexed by ‘55’. In other words, the first LCU addresses of the slices Slice 0-Slice 1 are ‘0’ and ‘48’, respectively.

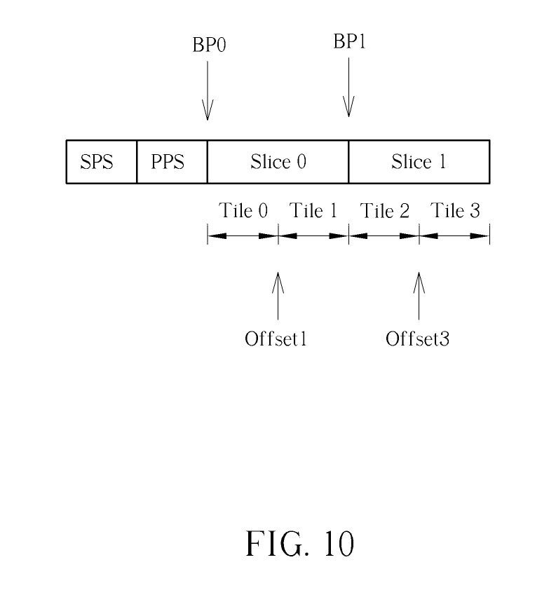

Please refer to FIG. 10, which is a diagram illustrating another example of a bitstream structure of the multi-tile picture. As mentioned above, tiles in a slice are raster scanned, and slices in the multi-tile picture are scanned sequentially. Hence, stream data of slices Slice 0-Slice 1 would be sequentially arranged in the video elementary stream demultiplexed and parsed by the DEMUX 102 shown in FIG. 1. Like the bitstream structure shown in FIG. 3, the stream of each slice includes a slice header (which includes auxiliary information) and a slice data (which is composed of encoded LCU data). The slice header would have the syntax slice_segment_address to indicate the first LCU address of the slice. Hence, when the DEMUX 102 parses the HEVC bitstream of the multi-tile picture 700, the DEMUX 102 obtains the first LCU address of each of slices Slice 0-Slice by finding the syntax slice_segment_address included in the corresponding slice header, and stores the first LCU address of each of slices Slice 0-Slice 1 into the data buffer 108. Further, when the DEMUX 102 parses the HEVC bitstream of the multi-tile picture 700, the DEMUX 102 also obtains a bitstream start address of each of slices Slice 0-Slice 1 in response to parsing the slice header of the corresponding slice. More specifically, when the DEMUX 102 finds that it is currently parsing a slice header of a specific slice, a bitstream start address of the specific slice can be determined correspondingly. Hence, the DEMUX 102 may store bitstream pointers BP0, BP1 of slices Slice 0-Slice 1 into the data buffer 108, where the bitstream pointers BP0, BP1 would point to respective bitstream start addresses of streams of slices Slice 0-Slice 1 stored in the video bitstream 104.

Because one slice maybe partitioned into multiple tiles, the tile offset syntax is included in the HEVC slice header. In this embodiment, the DEMUX 102 further parses the slice header to obtain a bitstream offset for each tile which is scanned after the first tile in the slice according to the raster scan order. The tile offset syntax in HEVC slice header is illustrated as below.

if( tiles_enabled_flag | | entropy_coding_sync_enabled_flag ) {
num_entry_point_offsets
if( num_entry_point_offsets > 0 ) {
offset_len_minus1
for( i = 0; i < num_entry_point_offsets; i++ )
entry_point_offset[ i ]}
}

The syntax element num_entry_point_offsets indicates the number of bitstream offsets. The syntax element offset_len_minus1 indicates the bit length of each bitstream offset. The syntax element entry_point_offset records a bitstream offset for one tile. In this embodiment, a bitstream offset Offset1 between the bitstream start address of the slice Slice 0 (i.e., the bitstream start address of the tile Tile 0) and the bitstream start address of the tile Tile 1 is obtained from the tile offset syntax in the slice header of the slice Slice 0, and a bitstream offset Offset3 between the bitstream start address of the slice Slice 1 (i.e., the bitstream start address of the tile Tile 2) and the bitstream start address of the tile Tile 3 is obtained from the tile offset syntax in the slice header of the slice Slice 1.

Based on the bitstream pointers and the first LCU addresses of slices Slice 0-Slice 1, bitstream start addresses of tiles Tile 0 and Tile 2 within the multi-tile picture 700 can be easily identified. Besides, based on the bitstream pointers and the first LCU addresses of slices Slice 0-Slice 1 and bitstream offsets of tiles Tile 1 and Tile 3, bitstream start addresses of tiles Tile 1 and Tile 3 within the multi-tile picture 700 can be easily identified.

As mentioned above, there is one picture parameter set (PPS) included in the bitstream of the multi-tile picture, where the PPS would have the tile syntax indicative of tile partitioning information (i.e., arrangement of tiles in the multi-tile picture). Hence, based on the tile partitioning information parsed by the DEMUX 102, the tile processing circuit 110 is able to calculate the first LCU address of each tile included in the multi-tile picture 700. In this example, the tile processing circuit 110 determines that the first LCU addresses of tiles Tile 0-Tile 3 are indexed by ‘0’, ‘7’, ‘48’ and ‘55’, respectively, and then stores the first LCU addresses of tiles Tile 0-Tile 3 into the data buffer 108.

As can be known from FIG. 8 and FIG. 9, the bitstream start address of the slice Slice 0 is also the bitstream start address of the tile Tile 0, and the bitstream start address of the slice Slice 1 is also the bitstream start address of the tile Tile 2. Hence, when the tile processing circuit 110 finds that one of the slices Slice 0 and Slice 1 has the first LCU address identical to the first LCU address of a specific tile requested by an application, the tile processing circuit 110 sets the bitstream start address of the specific tile by the bitstream start address pointed to by the bitstream point of the found slice. However, when the tile processing circuit 110 finds that none of the slices Slice 0 and Slice 1 has the first LCU address identical to the first LCU address of a specific tile requested by an application, this implies that the requested specific tile is not the first tile within any of the slices Slice 0 and Slice according to the raster scan order, the bitstream offset of the specific tile is used to determine the bitstream start address of the specific tile. More specifically, the tile processing circuit 110 adds the bitstream offset of the specific tile to the bitstream start address of a specific slice in which the specific tile is included, thereby generating the bitstream start address of the specific tile.

In a case where an ROI decoding application wants to decode the specific tile only, the tile processing circuit 110 sets the bitstream start address of the specific tile by the bitstream start address of a specific slice or a sum of the bitstream start address of a specific slice and the bitstream offset of the specific tile as the bitstream start address of the specific tile. Therefore, the video decoder 106 directly retrieves the bitstream of the specific tile from the video elementary stream stored in the video bitstream buffer 104, and accomplishes the ROI decoding for the specific tile. In another case where a multi-core processing application wants to decode multiple specific tiles simultaneously, the tile processing circuit 110 determines bitstream start addresses of the specific tiles by bitstream start addresses of multiple specific slices or a plurality of sums each being a bitstream start address of one specific slice plus a bitstream offset of one specific tile. Therefore, the video decoder 106 directly retrieves bitstreams of the specific tiles from the video elementary stream stored in the video bitstream buffer 104, and accomplishes the multi-core processing for the specific tiles.

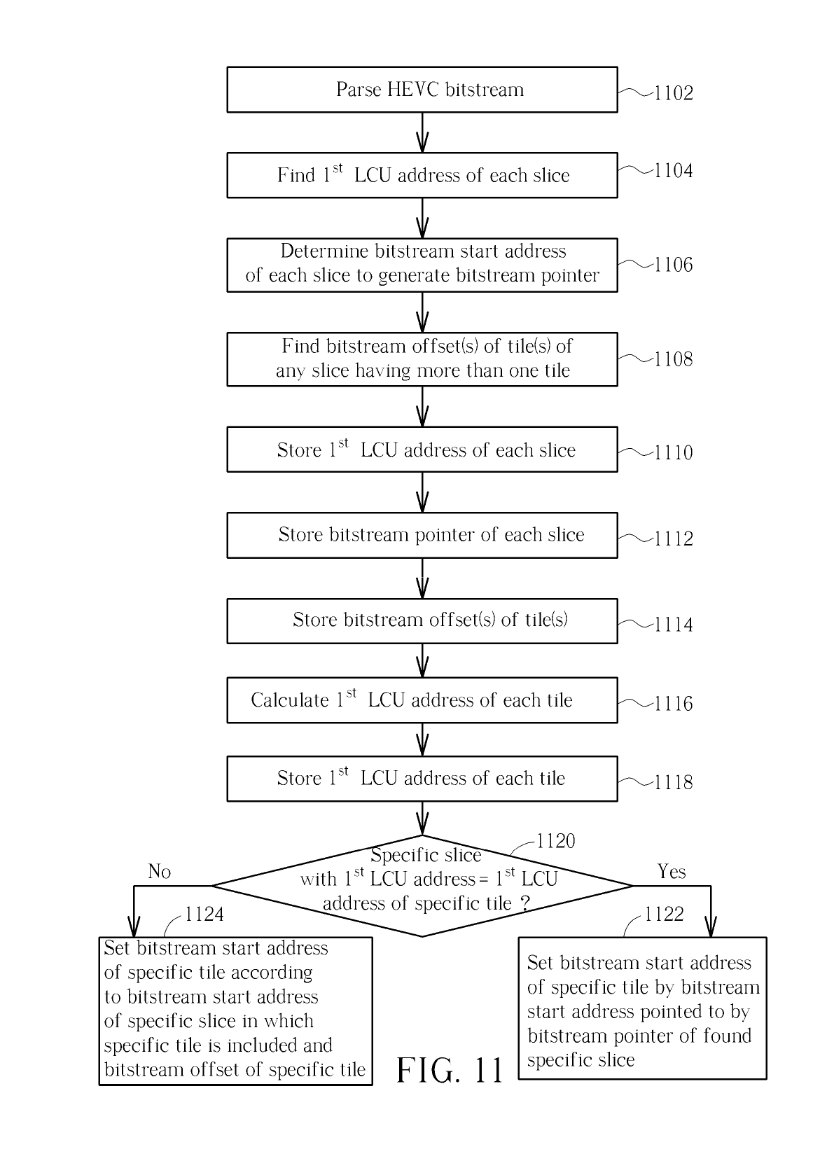

Please refer to FIG. 11, which is a flowchart illustrating a second tile processing method according to an embodiment of the present invention. The second tile processing method may be employed by the tile processing apparatus 100 under the second scenario. Provided that the result is substantially the same, the steps are not required to be executed in the exact order shown in FIG. 11. Besides, the flow is allowed to omit one or more of steps and/or include one or more additional steps, depending upon actual design consideration. The operation of getting the bitstream start address for a specific tile may be briefly summarized as follows.

Step 1102: Parse an HEVC bitstream (e.g., a video elementary stream having the multi-tile picture to be processed).

Step 1104: Find the first LCU address of each slice according to the syntax slice segment address in the slice header of each slice.

Step 1106: Determine a bitstream start address of each slice to generate a bitstream pointer.

Step 1108: Find bitstream offset(s) of tile(s) according to the tile offset syntax in the slice header of each slice.

Step 1110: Store the first LCU address of each slice into a data buffer (e.g., a memory).

Step 1112: Store the bitstream pointer of each slice into the data buffer.

Step 1114: Store bitstream offset(s) of tile(s) into the data buffer.

Step 1116: Calculate the first LCU address of each tile according to the tile syntax in the picture parameter set (PPS).

Step 1118: Store the first LCU address of each tile into the data buffer.

Step 1120: Check if there is a specific slice with the first LCU address identical to the first LCU address of a specific tile requested by an application. If yes, go to step 1122; otherwise, go to step 1124.

Step 1122: Set the bitstream start address of the specific tile by the bitstream start address pointed to by the bitstream pointer of the found specific slice.

Step 1124: Set the bitstream start address of the specific tile according to the bitstream start address of the specific slice in which the specific tile is included and the bitstream offset of the specific tile.

It should be noted that steps 1120, 1122 and 1124 maybe repeated to thereby output bitstream start addresses of multiple specific tiles requested by the application. As a person skilled in the pertinent art can readily understand details of each step shown in FIG. 11 after reading above paragraphs directed to the tile processing apparatus 100 operating under the second scenario, further description is omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A tile processing method, comprising:
parsing a bitstream of a multi-tile picture for deriving bitstream address related information from a segment header of at least a specific segment of the multi-tile picture; and
utilizing a tile processing circuit for receiving at least the bitstream address related information and referring to at least the received bitstream address related information to determine a bitstream start address of a specific tile of the multi-tile picture.

2. The tile processing method of claim 1, wherein the specific segment is included in the specific tile.

3. The tile processing method of claim 2, wherein the specific segment is a first segment of a plurality of segments included in the specific tile according to a scan order.

4. The tile processing method of claim 2, wherein the segment header of the specific segment indicates a first largest coding unit (LCU) address of the specific segment; the step of parsing the bitstream of the multi-tile picture further comprises: parsing tile partitioning information in the bitstream, and deriving a first LCU address of the specific tile from the tile partitioning information; and step of receiving at least the bitstream address related information comprises:
searching for a segment having a first LCU address identical to the first LCU address of the specific tile; and
when the first LCU address of the specific segment is found identical to the first LCU address of the specific tile, receiving the bitstream address related information derived from the specific segment.

5. The tile processing method of claim 2, wherein the segment header of the specific segment indicates a first largest coding unit (LCU) address of the specific segment; the step of deriving the bitstream address related information from the segment header comprises: obtaining a bitstream start address of the specific segment in response to parsing the segment header of the specific segment; and the step of referring to the received at least the bitstream address related information to determine the bitstream start address of the specific tile comprises: setting the bitstream start address of the specific tile by the bitstream start address of the specific segment.

6. The tile processing method of claim 1, wherein the specific tile is included in the specific segment.

7. The tile processing method of claim 6, wherein the specific tile is a first tile of a plurality of tiles included in the specific segment according to a scan order.

8. The tile processing method of claim 6, wherein the specific tile is not a first tile of a plurality of tiles included in the specific segment according to a scan order.

9. The tile processing method of claim 6, wherein the segment header of the specific segment indicates a first largest coding unit (LCU) address of the specific segment; the step of parsing the bitstream of the multi-tile picture further comprises: parsing tile partitioning information in the bitstream of the multi-tile picture, and deriving a first LCU address of the specific tile from the tile partitioning information; the step of deriving the bitstream address related information from the segment header comprises: obtaining a bitstream start address of the specific segment in response to parsing the segment header of the specific segment; and step of referring to at least the received bitstream address related information to determine the bitstream start address of the specific tile comprises:
when the first LCU address of the specific tile is identical to the first LCU address of the specific segment, setting the bitstream start address of the specific tile by the bitstream start address of the specific segment.

10. The tile processing method of claim 6, wherein the segment header of the specific segment indicates a first largest coding unit (LCU) address of the specific segment and a bitstream offset of the specific tile; the step of parsing the bitstream of the multi-tile picture further comprises: parsing tile partitioning information in the bitstream of the multi-tile picture, and deriving a first LCU address of the specific tile from the tile partitioning information; the step of deriving the bitstream address related information from the segment header comprises: obtaining a bitstream start address of the specific segment in response to parsing the segment header of the specific segment, and obtaining the bitstream offset of the specific tile; and step of referring to at least the received bitstream address related information to determine the bitstream start address of the specific tile comprises:
when the first LCU address of the specific tile is different from the first LCU address of the specific segment, setting the bitstream start address of the specific tile according to the bitstream start address of the specific segment and the bitstream offset of the specific tile.

11. A tile processing apparatus, comprising:
a demultiplexer, arranged to parse a bitstream of a multi-tile picture for deriving bitstream address related information from a segment header of at least a specific segment of the multi-tile picture; and
a tile processing circuit, arranged for receiving at least the bitstream address related information and referring to at least the received bitstream address related information to determine a bitstream start address of a specific tile of the multi-tile picture.

12. The tile processing apparatus of claim 11, wherein the specific segment is included in the specific tile.

13. The tile processing apparatus of claim 12, wherein the specific segment is a first segment of a plurality of segments included in the specific tile according to a scan order.

14. The tile processing apparatus of claim 12, wherein the segment header of the specific segment indicates a first largest coding unit (LCU) address of the specific segment; the demultiplexer parses tile partitioning information in the bitstream, and the tile processing circuit further derives a first LCU address of the specific tile from the tile partitioning information; and the tile processing circuit searches for a segment having a first LCU address identical to the first LCU address of the specific tile, and receives the bitstream address related information derived from the specific segment when the first LCU address of the specific segment is found identical to the first LCU address of the specific tile.

15. The tile processing apparatus of claim 12, wherein the segment header of the specific segment indicates a first largest coding unit (LCU) address of the specific segment; the demultiplexer obtains a bitstream start address of the specific segment as the bitstream address related information in response to parsing the segment header of the specific segment; and the tile processing circuit sets the bitstream start address of the specific tile by the bitstream start address of the specific segment.

16. The tile processing apparatus of claim 11, wherein the specific tile is included in the specific segment.

17. The tile processing apparatus of claim 16, wherein the specific tile is a first tile of a plurality of tiles included in the specific segment according to a scan order.

18. The tile processing apparatus of claim 16, wherein the specific tile is not a first tile of a plurality of tiles included in the specific segment according to a scan order.

19. The tile processing apparatus of claim 16, wherein the segment header of the specific segment indicates a first largest coding unit (LCU) address of the specific segment; the demultiplexer further parses tile partitioning information in the bitstream of the multi-tile picture, and the tile processing circuit further derives a first LCU address of the specific tile from the tile partitioning information; the demultiplexer obtains a bitstream start address of the specific segment as the bitstream address related information in response to parsing the segment header of the specific segment; and the tile processing circuit sets the bitstream start address of the specific tile by the bitstream start address of the specific segment when the first LCU address of the specific tile is identical to the first LCU address of the specific segment.

20. The tile processing apparatus of claim 16, wherein the segment header of the specific segment indicates a first largest coding unit (LCU) address of the specific segment and a bitstream offset of the specific tile; the demultiplexer further parses tile partitioning information in the bitstream of the multi-tile picture, and the tile processing circuit derives a first LCU address of the specific tile from the tile partitioning information; the demultiplexer derives the bitstream address related information by obtaining a bitstream start address of the specific segment in response to parsing the segment header of the specific segment, and further obtaining the bitstream offset of the specific tile; and the tile processing circuit sets the bitstream start address of the specific tile according to the bitstream start address of the specific segment and the bitstream offset of the specific tile when the first LCU address of the specific tile is different from the first LCU address of the specific segment.
